(19) United States
(12) Patent Application Publication
(10) Pub. No.: US 2005/0217807 A1
(43) Pub. Date: Oct. 6, 2005

(54) Reinforced sectional door for cargo body

(75) Inventors: Larry W. Brim, Kenton, OH (US); Charles F. Kellogg, Marion, OH (US)

Correspondence Address: MICHAEL E. MARTIN;GARDERE WYNNE SEWELL LLP, 3000 THANKSGIVING TOWER, 1601 ELM STREET, SUITE 3000, DALLAS, TX, 75201, US

(73) Assignee: OVERHEAD DOOR CORPORATION, FARMERS BRANCH, TX (US)

(21) Appl. No.: 11/135,955

(22) Filed: May 24, 2005

Related U.S. Application Data
(63) Continuation-in-part of application No. 10/676,765, filed on Oct. 1, 2003.

(51) Int. Cl. E05D 15/16

(52) U.S. Cl. 160/201

(57) ABSTRACT

Lightweight sectional doors for cargo bodies and the like are reinforced by a reinforcing member supported on an inner wall surface of at least alternate ones of the panels of a multipanel door. The reinforcing member comprises an elongated, preferably extruded member having spaced apart coplanar flanges and an arcuate web interposed the flanges. An integral rib is disposed at the midpoint of the arcuate web to provide additional stiffness for the reinforcing member. The reinforcing member may be secured to selected door panels by mechanical fasteners, such as rivets, projecting through plastic sleeves disposed in slots in the flanges to allow for differential thermal expansion of the panels and the reinforcing members.

### CROSS-REFERENCE TO RELATED APPLICATION

This application is a continuation in-part of U.S. patent application Ser. No. 10/676,765 filed Oct. 1, 2003.

### BACKGROUND OF THE INVENTION

Sectional upward acting doors are ubiquitous in applications for cargo bodies of freight vehicles, including motor trucks, for example. Mobile cargo bodies are, of necessity, fabricated of components which are required to be as light in weight as possible in order to reduce the tare weight of the vehicle. However, such components must also be of sufficient structural integrity as to not fail in normal use. Sectional upward acting doors for cargo bodies are preferably manufactured of lightweight extruded materials including aluminum and plastics.

One problem associated with the design and manufacture of sectional doors for cargo bodies pertains to the stiffness of the door panels required to resist damaging deflections due to rough treatment, wind loads and impacts from shifting cargo. A related problem with regard to cargo pertains to that wherein cargo items may shift during transport and lodge against the inside surface of the door and engage with projections, such as hinge components and the like which can prevent opening the door.

Another problem associated with the design and manufacture of sectional doors for cargo bodies pertains to thermal expansion of respective components of the door panels or sections when such components are made of different materials. Door panels made of molded or extruded polymer or composite materials typically have thermal co-efficients of expansion different from reinforcing members which may be used to reinforce or form structural parts of such panels. Accordingly, as a consequence, a problem arises which often results in undue stress on, distortion or warping of the panels at extreme temperatures, for example.

Accordingly, there has been a need to provide lightweight sectional doors for cargo bodies and the like which can be conveniently reinforced, when needed, by reinforcing members which in themselves are lightweight while adding the requisite rigidity to the door panels and wherein the reinforcing members do not aggravate but alleviate problems associated with cargo shifting against the door which would prevent the door from being opened. Moreover, there has been a need to provide such reinforcing members secured to the door panels in a way which will not cause undue stresses or bending of the door panels due to thermal expansion or contraction of the panels and the reinforcing members, respectively. It is to these ends that the present invention has been developed.

### SUMMARY OF THE INVENTION

The present invention provides an improved sectional, upward acting door, particularly useful for cargo bodies for freight vehicles, including motor trucks, for example.

In accordance with one aspect of the present invention, a sectional door is provided with elongated reinforcing members, preferably attached to selected ones of the door sections or panels as a component thereof when the overall dimensions of the door require the reinforcing member. The reinforcing member is preferably formed of extruded metal, such as aluminum, or plastic and is characterized by an elongated member having a cross section which is at least partially arcuate in shape to provide requisite stiffness when attached to a door panel. The reinforcing member is conveniently provided with opposed flanges and an arcuate web interposed the flanges and wherein the flanges provide for supporting the reinforcing member on a door panel by spaced apart fasteners. Still further, the cross section configuration of the reinforcing member includes a radial rib depending from the arcuate portion for added stiffness and to minimize deflection of the reinforcing member.

The present invention also provides a sectional door characterized by door panels which include a reinforcing member which may be mounted on at least alternate ones of the sections or panels making up the door and wherein the reinforcing member is of a configuration which minimizes the likelihood of objects, such as shifted freight or cargo, preventing the door from being opened when such objects are lodged against the door.

Still further, the present invention provides a sectional door characterized by door panels which include, respectively, a reinforcing member mounted on at least selected ones of the panels, including at least certain ones of the features mentioned hereinabove and also mounted on the panel in such a way so as to accommodate differential thermal expansion between the material forming the panel and the material forming the reinforcing member. An improved arrangement of fasteners for securing the reinforcing member to the panel accommodates differential thermal expansion without introducing stresses in the panel or the reinforcing member and without subjecting the panel to bending or other distortion resulting from differential thermal expansion.

Those skilled in the art will further appreciate the advantages and superior features of the invention together with other important aspects thereof upon reading the detailed description which follows in conjunction with the drawings.

### BRIEF DESCRIPTION OF THE DRAWINGS

FIG. 1 is a perspective view of a sectional upward acting door for a mobile cargo body including the panel reinforcing members of the present invention;

FIG. 2 is a detail section view taken generally along the line 2-2 of FIG. 1;

FIG. 3 is an elevation view of another embodiment of a sectional upward acting door for a mobile cargo body, including panels with reinforcing members secured thereto in accordance with another aspect of the present invention;

FIG. 4 is a detail section view taken generally along the line 4-4 of FIG. 3;

FIG. 5 is a detail section view taken along the same line as the view of FIG. 4, but on a larger scale;

FIG. 6 is a detail plan view, partially broken, of one of the panels of the door shown in FIG. 3 and illustrating further details of the reinforcing member for the panel; and

FIG. 7 is a detail section view taken along the line 7-7 of FIG. 6.

### DETAILED DESCRIPTION OF PREFERRED EMBODIMENTS

In the description which follows like parts are marked throughout the specification and drawing with the same reference numerals, respectively. The drawing figures are not necessarily to scale and certain features may be shown in generalized or somewhat schematic form in the interest of clarity and conciseness.

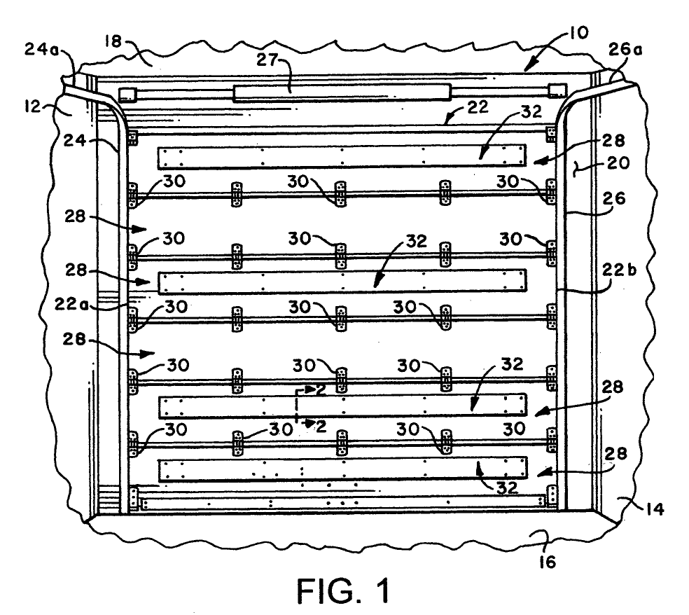

Referring to FIG. 1, there is shown a portion of a cargo body 10 of a mobile freight or cargo vehicle, such as motor truck, viewed from the interior of the cargo body. The cargo body 10 includes opposed side walls 12 and 14, a floor 16 and a ceiling 18. An outer wall 20 interconnects the other walls of the cargo body. An opening in wall 20, not shown, is closed by a sectional upward acting door 22 which may be of somewhat conventional construction except as described herein. The door 22 is mounted on opposed sets of guide rollers, not shown, for guidance and support by opposed track assemblies 24 and 26, also in a generally conventional manner, for movement of the door between a closed position, as shown in FIG. 1, and an open upwardly acted position, not shown, and wherein the door is typically disposed on horizontally extending track portions 24a and 26a, in a conventional manner. A conventional counterbalance mechanism 27 may be mounted on wall 20 above the door 22 for assisting a person in opening and closing the door.

The door 22 is preferably formed of plural, interconnected, lightweight sections or panels 28 which are interconnected by spaced apart hinge assemblies 30, respectively, which hinge assemblies are of rather conventional construction. The exemplary door 22 is made up of six interconnected panels 28, as shown. Depending on the overall height of the door greater or fewer than six panels may be required to make up a door similar to the door 22.

As a consequence of the construction of the panels 28, and depending somewhat on the overall length of the panels between opposed sides 22a and 22b of the door 22, at least alternate ones of the panels may require reinforcement to avoid unwanted deflection of the door away from the wall 20 as a result of any one or more of the events described hereinabove.

In accordance with the present invention reinforcing members 32 are provided on alternate ones of the panels 28 beginning at the uppermost panel and including the lowermost panel. Again, depending on the number of panels making up a door, such as the door 22, reinforcing members 32 may be disposed on only alternate panels, depending on whether an even or odd number of panels are required for making up the door. Provision of a reinforcing member 32 on the lowermost panel 28 is usually desired.

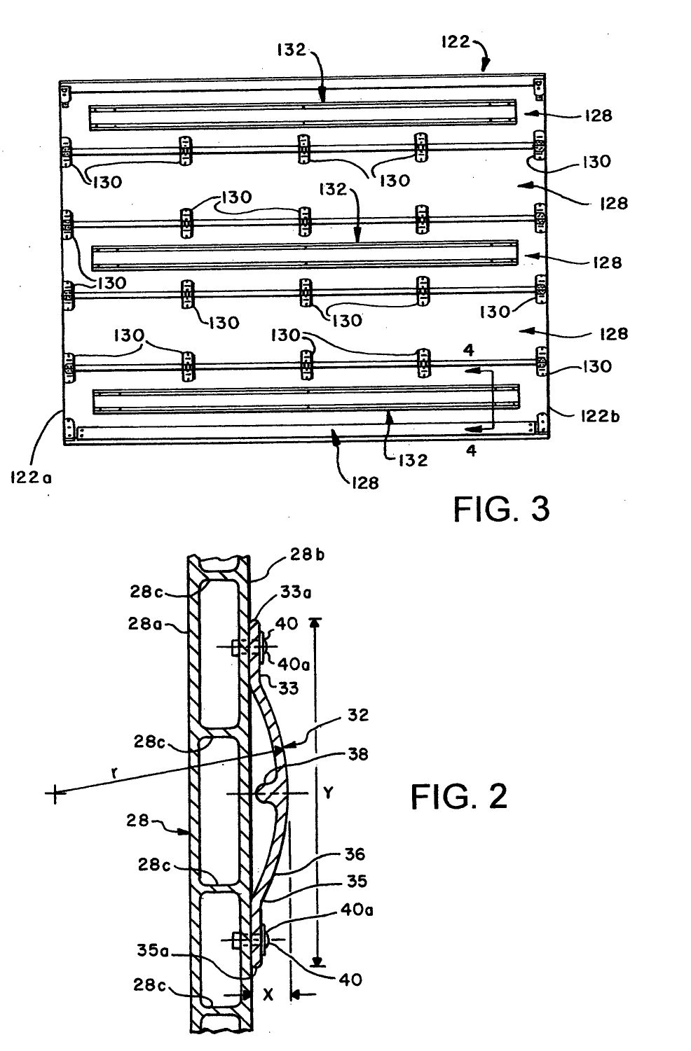

Referring now to FIG. 2, there is shown a portion of the cross section of one of the panels 28 having a reinforcing member 32 mounted thereon. A typical cross section configuration of a panel 28 is illustrated wherein the panel comprises a front or outer wall 28a spaced from and substantially parallel to an inner or back wall 28b. Walls 28a and 28b are interconnected by integral, substantially continuous webs 28c, as illustrated. Each of the panels 28 is preferably formed of extruded metal or plastic, as shown. Alternatively, the panels 28 may be cast or extruded of other materials.

Referring further to FIG. 2, reinforcing member 32 is characterized by spaced apart, elongated and coplanar flanges 33 and 35 which are interconnected by an arcuate web 36. An elongated depending or radial rib 38 is formed integral with the arcuate web 36 and is substantially equally spaced between the spaced apart flanges 33 and 35. The reinforcing members 32 may also be formed of cast or extruded plastic or metal. The reinforcing members 32 may be secured to the inner wall 28b of a panel 28 by spaced apart mechanical fasteners, such as rivets 40. Rivets 40 have a substantially flush or low profile head part 40a. Conventional screws or an adhesive may also be used to secure the reinforcing members 32 to the respective panels.

The configuration of the reinforcing members 32 is advantageous. The arcuate web 36 adds stiffness to the reinforcing member and, consequently, a panel secured thereto, which stiffness is further enhanced by the elongated rib 38. The coplanar flanges 33 and 35 formed integral with the arcuate web 36 provide a low profile presented to the interior space of the cargo body 10 which minimizes the chance of shifting cargo being caught on one of the reinforcing members and making it difficult or impossible to open the door 22.

In order to minimize the adverse effects of shifting cargo, the overall height “x”, FIG. 2, of the reinforcing members 32 is preferably at least as great as the height above the surface of the wall 28b of the respective hinges 30, so that cargo which is shifted directly against the door 22 is unlikely to be caught on one or more of the hinges during an attempt to open the door. Moreover, by providing a reinforcing member 32 on alternate panels of a multi panel sectional door, sufficient stiffness is obtained for a substantial range of panel dimensions typically used in cargo body doors. The width “y” of each reinforcing member 32, measured between opposed outer edges 33a and 35a of flanges 33 and 35, is preferably about 1.6 to 3.0 times the radius of curvature “r” of the web 36, and more preferably about 1.8 to 2.8 times the radius of curvature.

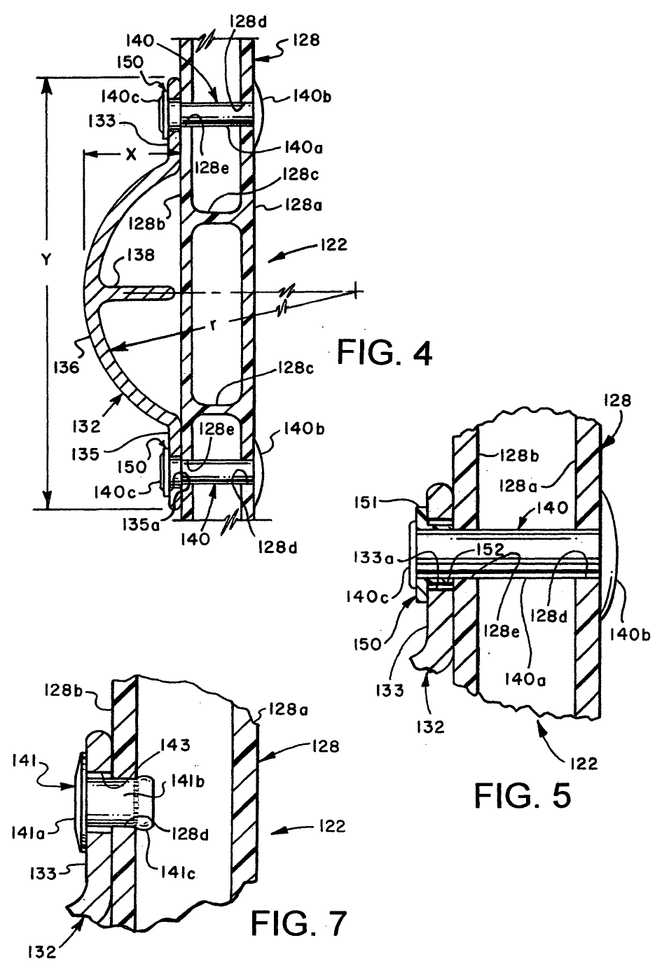

Referring now to FIGS. 3 through 7, another preferred embodiment of a sectional door for a mobile cargo body is illustrated and generally designated by the numeral 122. The door 122 is made up of plural panels 128 similar to the panels 28 and interconnected by hinges 130, as illustrated in FIG. 3. FIG. 3 also illustrates that door 122 comprises five interconnected panels 128 and wherein three of the panels are provided with a reinforcing member 132 similar in some respects to the reinforcing member 32. Door 122 has an overall width delimited by side edges 122a and 122b. Other combinations of reinforced and unreinforced panels may be provided in doors of other overall heights and widths. Referring to FIG. 4, in particular, each panel 128 includes a planar outer wall 128a spaced from a planar inner wall 128b and joined to inner wall 128b by spaced apart webs 128c. The panels 128 are preferably formed of extruded or molded polymer materials, such as a reinforced polyvinylchloride (PVC) composition, for example.

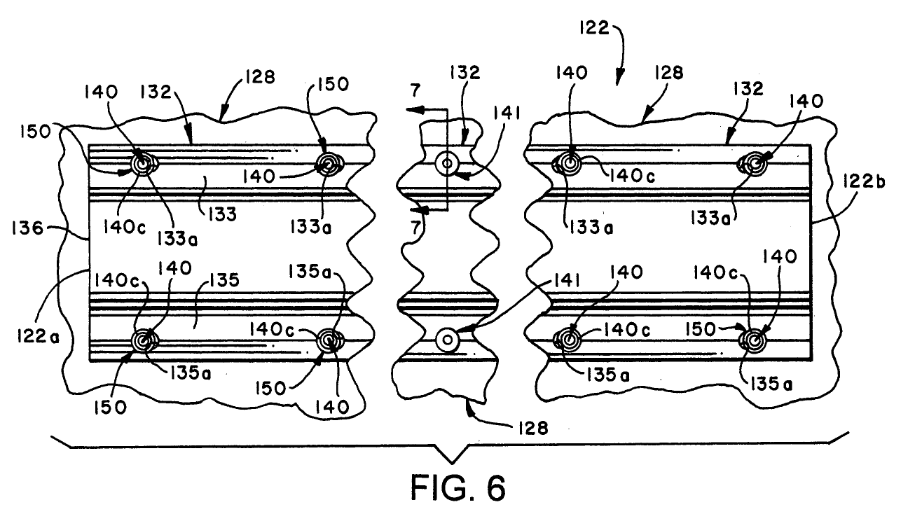

As shown particularly in FIGS. 4 and 6, each reinforcing member 132 is characterized by an elongated member having spaced apart elongated co-planar flanges 133 and 135 interconnected by an integral arcuate web 136. An elongated depending or radial rib 138 is integral with web 136, as illustrated in FIG. 4, and extends to a point adjacent the surface of inner wall 128b, but not contiguous therewith, as illustrated. Reinforcing members 132 are preferably formed of cast or extruded metal, including aluminum alloy, in particular. Reinforcing members 132 are secured to their respective panels 128 by sets of spaced apart rivet type fasteners 140 and 141, see FIGS. 6 and 7. Rivets 141 project through fastener receiving bores 143 formed in the respective flanges 133 and 135, as shown in particular for flange 133 in FIG. 7. Rivets 141 are of the blind type having a head 141a, a shank 141b and an upset end 141c. Rivets 141 project through suitable rivet receiving openings 128d, FIG. 7, as shown by a way of example. The rivet 141 for securing flange 135, FIG. 6, to panel 128 is configured substantially like the illustration of FIG. 7.

Flanges 133 and 135 are provided with spaced apart elongated rivet receiving slots 133a and 135a, respectively, as shown in FIG. 6. Rivets 140 are disposed in each of the slots, as illustrated.

Referring now to FIGS. 4 and 5, each of rivets 140 includes a shank part 140a, a head 140b and an upset end 140c as illustrated. Rivets 140 project through respective rivet receiving openings or holes 128d and 128e. Rivets 140 are provided with their heads 140b engaged with outer wall 128a, their shanks 148 projecting through openings 128d and 128e and through slots 133a and 135a and are formed with upset inner heads or ends 140c, as illustrated. However, rivet fasteners 140 also project through flanged sleeves 150, see FIG. 5, having a circular head or flange 151 and a cylindrical tubular shank portion 152. The outer diameter of the shank portion 152 is slightly less than the width of slots 133a and 135a, respectively.

Thanks to the provision of the elongated slots 133a and 135a and the sleeves 150, the reinforcing members 132 may be firmly secured to the panels 128 by fasteners 140 for reinforcing the panels against deflection while protecting cargo from engaging the hinges 130 in such a way as to prevent the door 122 from being opened and also allowing for differential thermal expansion between the panels 128 and the reinforcing members 132, respectively. Since the panels 128 are preferably formed of a thermoplastic or thermoset material, and the reinforcing members 132 are formed of extruded or cast metal, such as aluminum alloy, a noticeable differential expansion factor, namely the co-efficient of thermal expansion of the respective materials, must be dealt with. Accordingly, with the panel construction illustrated and described, the reinforcing members 132 may elongate without losing their reinforcing capability and without stressing the panels 128 or actually deflecting or warping the panels at conditions of ambient temperature extremes to which motor truck cargo bodies are normally exposed. Thanks also to the sleeves 150, which are preferably formed of a plastic, such as Nylon, the reinforcing members 132 may be firmly secured to the inner walls 128b of the panels 128 for reinforcing same while allowing the reinforcing members to elongate relative to the panels 128. In this respect, the slots 133a and 135a may have an overall length of about 1.5 to 2.0 times their width, depending on the materials being used and the placement of the fasteners in the slots at assembly. Accordingly, the reinforcing members 132 are firmly anchored to the panel members 128 at one set of fasteners 141 and while a second set of fasteners 140 allows the reinforcing members to undergo different thermal expansion than the panels on which they are mounted. Of course, the material co-efficients of thermal expansion of the panels 128 and the reinforcing members 132 may be reversed, depending on what materials are being used for these components.

Conventional engineering materials, as mentioned herein, may be used to fabricate the panels 28 and 128 and the reinforcing members 32 and 132 and the fabrication of same is believed to be within the purview of one of ordinary skill in the art of sectional doors for cargo bodies. The dimensional relationships between the overall width of the reinforcing members 32 and 132, the radii of the arcuate webs 36 and 136 and the height of the reinforcing members is also preferably such that the webs do not project more than a desired distance from the walls 28b or 128b while still providing the desired stiffness.

Although preferred embodiments of a reinforced sectional door have been described in detail herein, including the inventive reinforcing members 32 and 132, those skilled in the art will recognize that various substitutions and modifications may be made without departing from the scope and spirit of the appended claims.

1. In a sectional door, particularly adapted for use with mobile cargo bodies, a plurality of hingedly interconnected panels, at least selected ones of said panels each including an elongated reinforcing member mounted on an inner surface thereof, respectively, and comprising spaced apart coplanar flanges and a continuous arcuate web interposed and connected to said flanges for reinforcing the stiffness of said selected panels, respectively, said flanges being provided with elongated slots for receiving fasteners, respectively, securing said reinforcing members to said panels while allowing relative movement between said reinforcing members and said panels due to differential thermal expansion.

2. The invention set forth in claim 1 wherein:
each of said flanges is secured to said panel by at least one fastener disposed between said fasteners which are received in said slots.

3. The invention set forth in claim 1 wherein:
said reinforcing member includes a rib extending from said web toward said surface of said panel on which said reinforcing member is mounted.

4. The invention set forth in claim 1 wherein:
said fasteners comprise rivets projecting from an outer wall of said panel through an inner wall of said panel and through said slots, respectively.

5. The invention set forth in claim 4 wherein:
said rivets project through flanged sleeves disposed in said slots, respectively.

6. The invention set forth in claim 4 wherein:
said sleeves are formed of a thermoplastic.

7. The invention set forth in claim 6 wherein:
the overall width of said reinforcing member between spaced part outer edges of said flanges is about 1.6 to 3.0 times the radius of curvature of said web.

8. The invention set forth in claim 1 wherein:
said panels are formed of extruded plastic.

9. The invention set forth in claim 1 wherein:
said reinforcing members are formed of aluminum.

10. In a sectional door in a mobile cargo body, a plurality of panels interconnected by spaced apart hinges mounted on and projecting from inner surfaces of said panels, respectively, at least selected ones of said panels including an elongated reinforcing member mounted on said inner surfaces thereof, respectively, and comprising one of an extruded and cast elongated member having spaced apart coplanar flanges and a continuous arcuate web interposed and connected to said flanges for reinforcing the stiffness of said selected panels, respectively, said reinforcing members are mounted on said inner surfaces of said panels by spaced apart mechanical fasteners disposed at respective ones of said flanges, the overall width of said reinforcing members between spaced apart outer edges of said flanges is about 1.6 to 3.0 times the radius of curvature of said web, respectively, the height of said reinforcing members with respect to said inner surfaces is at least as great as the height of said hinges with respect to said inner surfaces, respectively, and said reinforcing members are connected to said panels in such a way as to allow relative movement between said panels and said reinforcing members, respectively, due to differential thermal expansion.

11. The invention set forth in claim 10 wherein:
said reinforcing members each include a rib extending from said web toward said inner surfaces of said panels on which said reinforcing members are mounted, respectively.

12. The invention set forth in claim 10 where:
the overall width of said reinforcing members is about 1.8 to 2.8 times the radius of curvature of said web.

13. The invention set forth in claim 10 wherein:
said flanges are provided with elongated slots for receiving said fasteners, respectively, for securing said reinforcing members to said panels while allowing relative movement between said reinforcing members and said panels due to differential thermal expansion.

14. The invention set forth in claim 13 wherein:
each of said flanges is secured to said panel by at least one fastener disposed between said fasteners which are received in said slots.

15. The invention set forth in claim 13 wherein:
said fasteners comprise rivets projecting from an outer wall of said panel through an inner wall of said panel and through said slots, respectively.

16. The invention set forth in claim 15 wherein:
said rivets project through plastic flanged sleeves disposed in said slots, respectively.

17. In a sectional door in a mobile cargo body, a plurality of panels interconnected by spaced apart hinges mounted on and projecting from inner surfaces of said panels, respectively, at least selected ones of said panels including an elongated reinforcing member mounted on said inner surface thereof, respectively, and comprising one of an extruded and cast elongated metal member having spaced apart coplanar flanges and a continuous arcuate web interposed and formed integral with said flanges, said reinforcing member including a rib extending from said arcuate web toward a said inner surface of said panel on which said reinforcing member is mounted, said reinforcing member being mounted on said inner surface of said panel by spaced apart mechanical fasteners disposed at respective ones of said flanges, the overall width of said reinforcing member between opposed spaced apart outer edges of said flanges is about 1.6 to 3.0 times the radius of curvature of said arcuate web, and the height of said reinforcing member with respect to said inner surface is at least as great as the height of said hinges with respect to said inner surface.

18. The invention set forth in claim 17 wherein:
alternate ones of said panels include one of said reinforcing members secured the said inner surface thereof, respectively.

19. The invention set forth in claim 17 wherein:
said flanges are provided with elongated slots for receiving said fasteners, respectively, for securing said reinforcing members to said panels while allowing relative movement between said reinforcing members and said panels due to differential thermal expansion.

20. The invention set forth in claim 17 wherein:
each of said flanges is secured to said panel by at least one fastener disposed between said fasteners which are received in said slots.

21. The invention set forth in claim 17 wherein:
said fasteners comprise rivets projecting from an outer wall of said panel through an inner wall of said panel and through said slots, respectively.

22. The invention set forth in claim 21 wherein:
said rivets project through plastic flanged sleeves disposed in said slots, respectively.
